(19) United States
(12) Patent Application Publication
(10) Pub. No.: US 2014/0146517 A1
(43) Pub. Date: May 29, 2014

(54) LIGHT EMISSION AND CONVERSION THROUGH A SPINNING SHAFT

(71) Applicant: AVAGO TECHNOLOGIES GENERAL IP (SINGAPORE) PTE., Singapore (SG)

(72) Inventors: Fook Chuin Ng, Penang (MY); Choon Guan Ko, Penang (MY)

(73) Assignee: Avago Technologies General IP (Singapore) Pte. Ltd., Singapore (SG)

(21) Appl. No.: 13/686,908

(22) Filed: Nov. 27, 2012

(51) Int. Cl. F21V 9/16

(52) U.S. Cl. CPC F21V 9/16
USPC 362/84

(57) ABSTRACT

An illumination device, system, and method are disclosed. The illumination device includes one or more light sources mounted on a core and a shaft that is configured to at least partially surround the core. The shaft may include one or more phosphor elements that are movable relative to the core and the one or more light sources. Movement of the shaft and the one or more phosphor elements may facilitate the production of white light and other non-white-lighting effects.

### FIELD OF THE DISCLOSURE

The present disclosure is generally directed toward light emitting devices.

### BACKGROUND

Light Emitting Diodes (LEDs) have many advantages over conventional light sources, such as incandescent, halogen and fluorescent lamps. These advantages include longer operating life, lower power consumption, and smaller size. Consequently, conventional light sources are increasingly being replaced with LEDs in traditional lighting applications. As an example, LEDs are currently being used in flashlights, camera flashes, traffic signal lights, automotive taillights and display devices. LEDs have also gained favor in residential, industrial, and retail lighting applications.

LED development began with infrared and red devices made with gallium arsenide. Advances in materials science have enabled making devices with ever-shorter wavelengths, emitting light in a variety of colors.

There are two primary ways of producing white light-emitting diodes (WLEDs)—LEDs that generate high-intensity white light. One is to use individual LEDs that emit three primary colors (red, green, and blue) and then mix all the colors to form white light. The other is to use a phosphor material to convert monochromatic light from a blue or Ultraviolet LED to broad-spectrum white light, much in the same way a fluorescent light bulb works.

One disadvantage to utilizing phosphor in connection with LEDs is that the phosphor degrades due to the operating conditions imposed on the phosphor. Specifically, the LED die(s) are known to generate significant heat during operation. The heat generated by the LED die(s) creates a high temperature environment about the phosphor if the phosphor is in contact with or near the LED die(s), which causes the phosphor to degrade more rapidly than if it were exposed to lower operating temperatures.

### SUMMARY

It is, therefore, one aspect of the present disclosure to provide an illumination device that overcomes the above-noted shortcomings. In particular, embodiments of the present disclosure introduce an illumination device having a core and a shaft with a gap that resides between the core and shaft. One or more light sources, such as LED dies, may be mounted on the core and configured to emit light away from the core toward the shaft. The shaft may be provided with one or more light-altering elements (e.g., filter, phosphor, lens, etc.) that alter the light emitted by the light sources in one way or another. In some embodiments, the shaft is equipped with one or more phosphor elements that convert the light emitted by the light source(s) mounted on the core into broad-spectrum white light.

In some embodiments, the shaft may be further configured to move or rotate relative to the core. More specifically, the shaft may be operably associated with a shaft motor and the shaft motor may cause the shaft to rotate relative to the core. Even more specifically, the shaft motor may be configured to rotate the shaft at a predetermined rotational speed to control the quality of light that ultimately leaves the illumination device. For example, the shaft motor may be configured to rotate the shaft at a relatively high speed to create a first illumination effect or a relatively low speed to create a second illumination effect. In some embodiments, the shaft motor may be attached to or have incorporated therein one or more light detectors that are configured to monitor the light emitted by the illumination device (e.g., ambient or environmental light conditions outside of the illumination device). Based on detected light conditions, the shaft motor may be configured to speed up or slow down the rotation of the shaft relative to the core.

In some embodiments, the illumination device described herein is capable of creating vivid color or white light depending upon the way in which the shaft is controlled. Different rotating speeds may be used to produce different colors or white light. In some embodiments, the light sources mounted on the core may correspond to blue or Ultraviolet LEDs that emit light toward the shaft. The emitted light can excite the phosphor elements to produce photoluminescence while the rotating shaft can mix or blend the excited photoluminescence.

Another advantage of the present disclosure is that the core can be configured to transfer and dissipate heat created by the light sources. The enhanced heat transfer properties offered by the core can help maintain the junction temperature of the light sources, thereby increasing their operational lifetime. Moreover, because the shaft and its phosphor element(s) are physically separated from the core and the light source(s), the deleterious effects of heat from the light sources on the phosphor can be minimized, thereby minimizing phosphor degradation.

The present disclosure will be further understood from the drawings and the following detailed description. Although this description sets forth specific details, it is understood that certain embodiments of the invention may be practiced without these specific details. It is also understood that in some instances, well-known circuits, components and techniques have not been shown in detail in order to avoid obscuring the understanding of the invention.

### BRIEF DESCRIPTION OF THE DRAWINGS

The present disclosure is described in conjunction with the appended figures:

FIG. 1 is a cross-sectional view of an illumination device in accordance with embodiments of the present disclosure;

FIG. 2 is an isometric view of an illumination device connected to a motor in accordance with embodiments of the present disclosure;

FIG. 3 is a cross-sectional view of an illumination device in accordance with embodiments of the present disclosure;

FIG. 4 is a cross-sectional view of an illumination device in accordance with embodiments of the present disclosure;

FIG. 5 is a cross-sectional view of an illumination device in accordance with embodiments of the present disclosure;

FIG. 6 is a cross-sectional view of an illumination device in accordance with embodiments of the present disclosure; and

FIG. 7 is a flow chart depicting a method of manufacturing and utilizing an illumination device in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It being understood that various changes may be made in the function and arrangement of elements without departing from the spirit and scope of the appended claims.

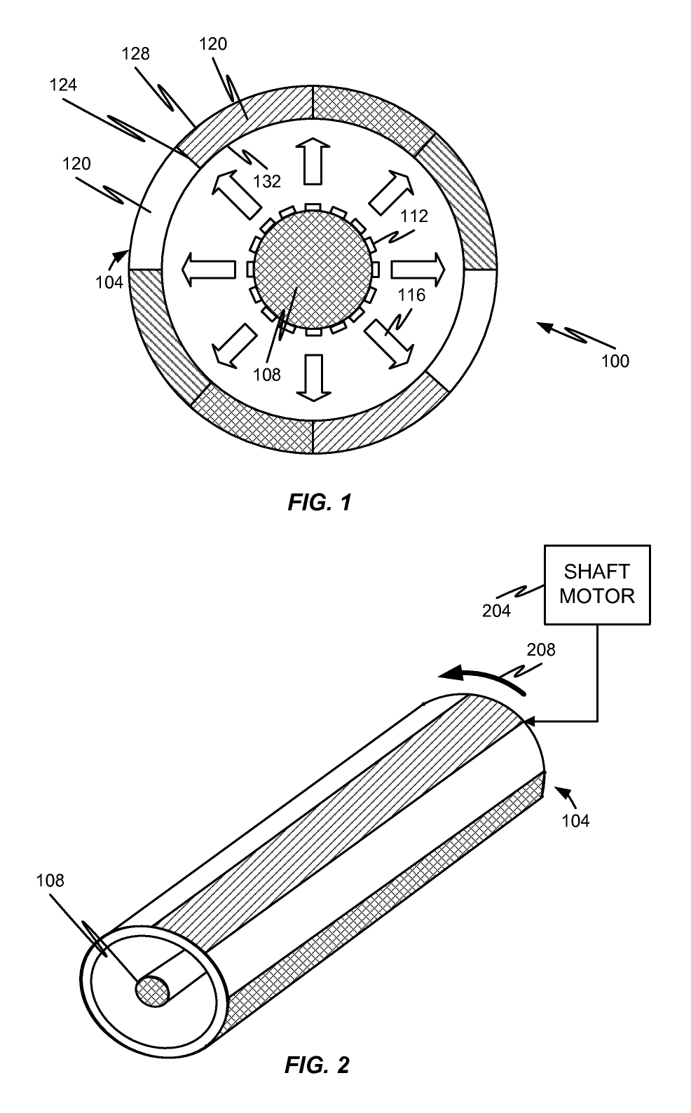

With reference now to FIG. 1, details of a first possible configuration for an illumination device 100 will be described in accordance with at least some embodiments of the present disclosure. The illumination device 100 may include a shaft 104 and a core 108. The core 108 may be at least partially surrounded or enclosed by the shaft 104 and in some embodiments, the shaft 104 completely surrounds the core 108. In even more specific embodiments, the core 108 may be contained within and possible centered within the hollow body of the shaft 104.

In the embodiment depicted in FIG. 1, the core 108 comprises a generally cylindrical shape (e.g., a rod-type core 108). It should be appreciated that non-cylindrical cores 108 can be used without departing from the scope of the present disclosure. Specifically, the core 108 may comprise any shape (e.g., sheet or planar, square, rectangular, triangular, etc.). In some embodiments, the core 108 may be constructed of any type of material that is substantially rigid or self-supporting. In more specific embodiments, the core 108 may comprise a cylindrically-shaped Printed Circuit Board (PCB), a traditional flat and rigid PCB, or the like. In other embodiments, the core 108 may comprise a flexible PCB that is wrapped around a rod having thermal dissipating properties (e.g., metal, conductive polymer, ceramic, or the like).

One possible function of the core 108 is to physically support and provide electrical current to one or more light sources 112. The one or more light source 112 may be configured to be mounted to the outer surface of the core 108. In some embodiments, the core 108 may comprise a PCB component and the light source(s) 112 may be configured for surface mounting to the PCB component of the core 108. In some embodiments, the light source(s) 112 may be configured for thru-hole mounting to the PCB component of the core 108. In some embodiments, some light source(s) 112 may correspond to surface mount device and other light source(s) 112 may correspond to thru-hole devices. In some embodiments, some light source(s) 112 may correspond to one or more Organic LED (OLED) sheets or films. The OLED sheet may be wrapped around the core 108 and have its electrodes connected to different leads.

Although not depicted, other electrical and electro-mechanical device may also be mounted on the outer surface of the core 108. For instance, resistors, capacitors, inductors, transistors, sensors, motor components, etc. may be mounted on the core 108.

In some embodiments, the light source 112 is configured to emit light 116 of a predetermined wavelength or color. More specifically, the light source(s) 112 may be configured to produce and emit light 116 that is approximately blue or Ultraviolet (e.g., with a wavelength of greater than approximately 445 nm). More specifically, the light source(s) 112 may correspond to one or more LED dies. The LED die(s) may be configured to emit substantially blue or Ultraviolet light 116 when current is passed therethrough (e.g., when the LED is activated with current flowing from the PCB of the core 108). Any type of known LED may be used for the light source(s) 112 and they light source(s) 112 may be mounted and electrically connected to the core 108 in any known fashion (e.g., via wires, bonding pads, surface contacts, etc.).

In some embodiments, the light source(s) 112 are configured to inherently produce heat during operation. The material of the core 108 may be selected to help dissipate heat produced by the light source(s) 112 away from the light source(s) 112. More specifically, as noted above, the core 108 may comprise a flexible PCB mounted on a heat sink. The heat sink may comprise any type of material that is known to be thermally conductive. In other words, the material of the core 108 may be used to carry heat away from the light source(s) to increase their life span.

In some embodiments, the length of the core 108 may be similar in dimension to traditional fluorescent light tubes (e.g., approximately 1-2 m in length). In particular, the core 108 may have coupling mechanisms at each of its ends that enable the illumination device 100 to replace a traditional fluorescent light. Examples of such coupling mechanisms are described, for instance, in U.S. Pat. No. 6,860,628 to Robertson et al., the entire contents of which are hereby incorporated herein by reference.

The shaft 104 of the illumination device 100 may provide several functions. In some embodiments, the shaft 104 may comprise one or more shaft sections 120 that are each configured to condition the light 116 emitted by the light source(s) 112. The shaft sections 120 may comprise similar or different light-conditioning properties. In some embodiments, a first shaft section 120 may provide a first light-conditioning property and a second shaft section 120 may comprise a second light-conditioning property that is different from the first section. More specifically, some of the shaft sections 120 may comprise one type of material while other shaft sections 120 may comprise a different type of material.

Although the shaft 104 of FIG. 1 is depicted as having eight sections 120, it should be appreciated that a shaft 104 may be equipped with a greater or lesser number of shaft sections 120 without departing from the scope of the present disclosure. Specifically, the shaft 104 may comprise one, two, three, four, five, . . . , twenty or more shaft sections 120 without departing from the scope of the present disclosure.

In some embodiments, the shaft 104 comprises an inner shaft surface 132 and an outer shaft surface 128. One or more light-altering or conditioning materials may be contained between the inner shaft surface 132 and outer shaft surface 128. Furthermore each section 120 may be separated by its adjacent sections 120 by a section boundary 124. The section boundary 124 may correspond to an area or point where there is a transition from one material of one section 120 to another material of another section 120. Even more specifically, some sections 120 may be provided with a first type of phosphor material while other sections 120 may be provided with a second type of phosphor material. The different sections 120 may also comprise other types of non-phosphor materials that differ from one another. For instance, some of the sections 120 may comprise materials that filter or shape light in one way while other sections 120 may comprise materials that filter or shape light in another way. It may also be possible that some sections 120 comprise a phosphor or filter material while other sections 120 are completely transparent or devoid of a phosphor or filter material.

Where at least some of the sections 120 comprise a phosphor material, the phosphor material employed may be provided to convert the light 116 emitted by the light source 112 from one color into another color, for example by absorbing light of a predetermined frequency and/or emitting light of a predetermined frequency. More specifically, the phosphor material used in the shaft 104 may comprise a phosphor powder, a resin (e.g., resin A), and a hardener for the resin (e.g., hardener for resin A). Examples of the types of resin that may be used as resin A include, without limitation, urethane based copolymers and polyester resin based copolymers. The hardeners for the resin may correspond to thermal, ultraviolet, or chemical-based hardeners that, when subjected to the appropriate environment (e.g., heat, light, chemical, etc.) cause the resin to cure or substantially harden. In some embodiments, the resin and the resin hardener provided in the phosphor material may be substantially clear or translucent.

The phosphor component of the material in the shaft 104 may correspond to any type of known phosphor or combination of phosphor compounds. More specifically, the phosphor included in the phosphor material may include, without limitation, one or both of a copper-activated zinc sulfide and a silver-activated zinc sulfide (e.g., zinc sulfide silver). The host materials used for the phosphor may include any one or combination of oxides, nitrides and oxynitrides, sulfides, selenides, halides or silicates of zinc, cadmium, manganese, aluminum, silicon, and various rare earth metals. It may also be desirable to include other materials (such as nickel) to quench the afterglow and shorten the decay part of the phosphor emission characteristics.

In a very specific, but non-limiting example, the light source(s) 112 may correspond to a blue or Ultraviolet-emitting LEDs and the phosphor materials of each section 120 may comprise any material or combination materials (using the same or different combination of materials described above) that emit at longer wavelengths than is produced by the light source(s) 112, thereby giving a full spectrum of visible light (e.g., white light). In other embodiments, some of the sections 120 may comprise phosphor materials that, when excited, emit light of a first wavelength while other sections may comprise phosphor materials that, when excited, emit light of a second wavelength.

In some embodiments, the shaft 104 may be configured to rotate or move relative to the core 108. If the shaft 104 comprises a number of sections 120 having different optical properties (e.g., different phosphor materials, different filter materials, different light-shaping properties, etc.), then the rotation of the shaft 104 relative to the core 108 may help to blend the excited photoluminescence of each section 120. This may help in the production of white light or it may help to create other lighting conditions.

Another advantage to providing the phosphor material in the shaft 104, is that the phosphor material can be physically separated from the primary source of heat in the illumination device 100—the light source(s) 112. By maintaining a gap between the light source(s) 112 and the shaft 104, the phosphor material can avoid the unnecessary exposure to heat, which would eventually lead to phosphor degradation. Furthermore, since the core 108 is acting as the primary heat sink in the illumination device 100, the amount of heat radiating toward the shaft 104 can be minimized.

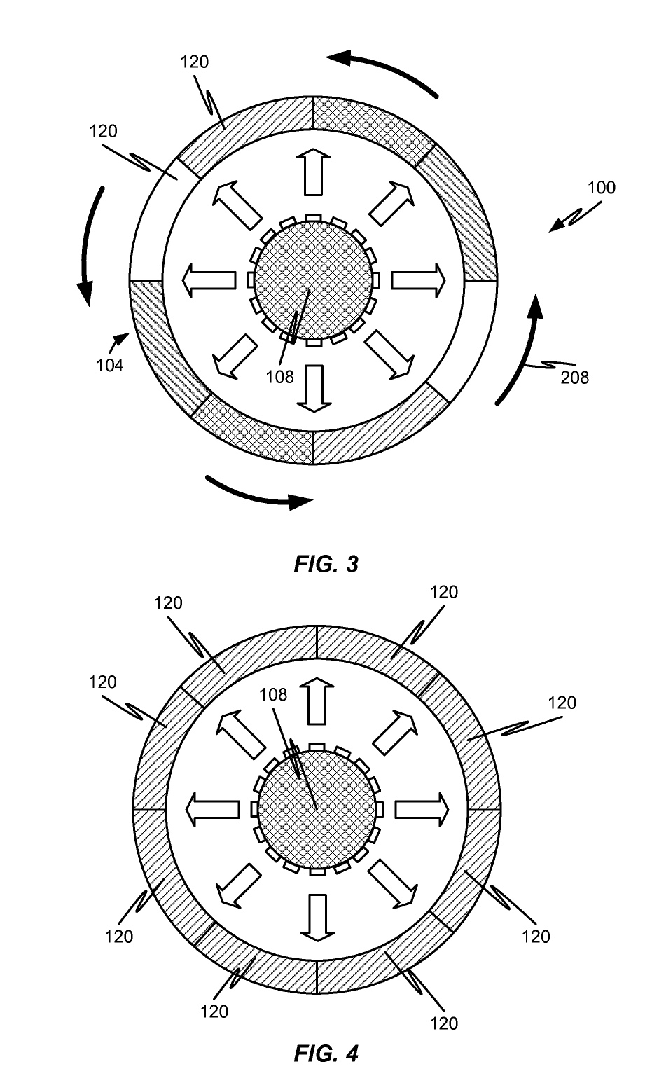

As can be seen in FIGS. 2 and 3, the rotational direction 208 and speed of the shaft 104 relative to the core 108 may be controlled, at least in part, by a shaft motor 204. In some embodiments, the shaft 104 may be rotatably mounted on or about the core 108, thereby enabling the shaft 104 to rotate or move relative to the core 108. Specifically, there may be one or more bearings, wheels, gears, or the like that fix the position of the shaft 104 relative to the core 108 as well as enable the shaft 104 to rotate about the core 108. In some embodiments, the shaft motor 204 may correspond to a servo-motor or the like that is configured to engage one or more gears. The shaft 108 may also comprise one or more gears or teeth that engage gears at one of its ends that are coupled to the gear(s) being driven by the shaft motor 204. Rotation of the gear(s) via the shaft motor 204 may cause the shaft 104 to rotate in the direction indication by arrow 208. It should be appreciated that the shaft 104 may be configured to rotate in either direction either by control of the single shaft motor 204 or by multiple shaft motors.

In some embodiments, the shaft motor 204 may be a relatively simple device that simply rotates the shaft 104 at a predetermined speed when activated. In some embodiments, the shaft motor 204 may be activated by a simple switch that is either on the shaft motor 204, that is remotely controlled, or that is connected to a wall switch that also controls activation of the light source(s) 112.

In more elaborate embodiments, the shaft motor 204 may include a logic circuit that enables an intelligent control of the shaft 104 rotation. Specifically, the shaft motor 204 may be configured to automatically alter the speed of shaft 104 rotation based on a predetermined timing pattern (e.g., to automatically and continuously create different lighting effects). In other embodiments, the shaft motor 204 may be connected to one or more light sensors that detect light emitted by the illumination device 100. For example, the shaft motor 204 may be connected to environmental or ambient light sensors that detect the light emitted by the illumination device 100 and/or other light in a room in which the illumination device 100 is mounted. Based on the light detected at the light detectors, the shaft motor 204 may change the speed at which the shaft 104 rotates, the direction in which the shaft 104 rotates, whether the shaft 104 rotates at all, and the like.

When the shaft 104 comprises different sections 120 having different materials, the rotation of the shaft 104 can facilitate the creation of different lighting effects and/or the creation of white light. In some embodiments, the shaft 104 may include irregular, linear, or mosaic phosphor patterns and the rotation of the shaft 104 relative to the core 108 may take advantage of the phosphor patterning in the shaft 104 to create unique lighting conditions.

In some embodiments, the shaft 104 may be configured to be removed from the illumination device 100. In other words, the shaft 104 may be removed and possibly replaced with other shafts 104 having different properties. Variants of the types of shafts 104 that may be utilized in accordance with embodiments of the present disclosure will now be described.

FIG. 4 shows a shaft 104 with sections 120 of the same type. Such a shaft 104 may not require rotation or movement via the shaft motor 204. Furthermore, where the shaft 104 comprises a single type of material (e.g., a single phosphor type), it may be unnecessary for the different sections 120. In such an embodiments, a single continuous material may be used for the shaft 104.

The shafts 104 depicted in FIGS. 1-4 may be manufactured by molding a phosphor material (possibly along with other materials) into the shape of the shaft 104. The molding may be accomplished via injection molding, cast molding, etc. A shaft 104 manufactured according to molding techniques may be relatively uniform in thickness and material consistency from the inner shaft surface 132 to the outer shaft surface 128. Furthermore, the sections 120 may be manufactured separately and then the sections 120 may be connected or adhered together to achieve the multi-sectioned shaft 104. In other embodiments, the different sections 120 may be molded during a single mold step and physical boundaries at the section boundaries 124 may be established with barrier materials, such as metal, plastic, or the like. These barrier materials may be kept in the shaft 104 and incorporated into the final shaft 104 product or they may be removed prior to finalizing construction of the shaft 104.

FIG. 5 shows another possible shaft 104 variant in accordance with embodiments of the present disclosure. The illumination device 100 may comprise a shaft having an inner shaft substrate 504 and an outer phosphor layer 508. The shaft substrate 504 may correspond to a flexible transparent or translucent material that is shaped in the desired configuration. Before or after the shaft substrate 504 is shaped, the phosphor layer 508 may be established on the outer surface of the shaft substrate 504. In some embodiments, the phosphor layer 508 may be printed on the shaft substrate 504 via any type of known printing or deposition techniques. As some embodiments, thin film printing, Chemical Vapor Deposition (CVD), Atomic Layer Deposition (ALD), inkjet printing, or the like can be used to apply the phosphor layer 508 onto the shaft substrate 508. The phosphor of the phosphor layer 508 may be applied to the shaft substrate 504 by itself or in combination with another carrier material (e.g., a resin and resin hardener).

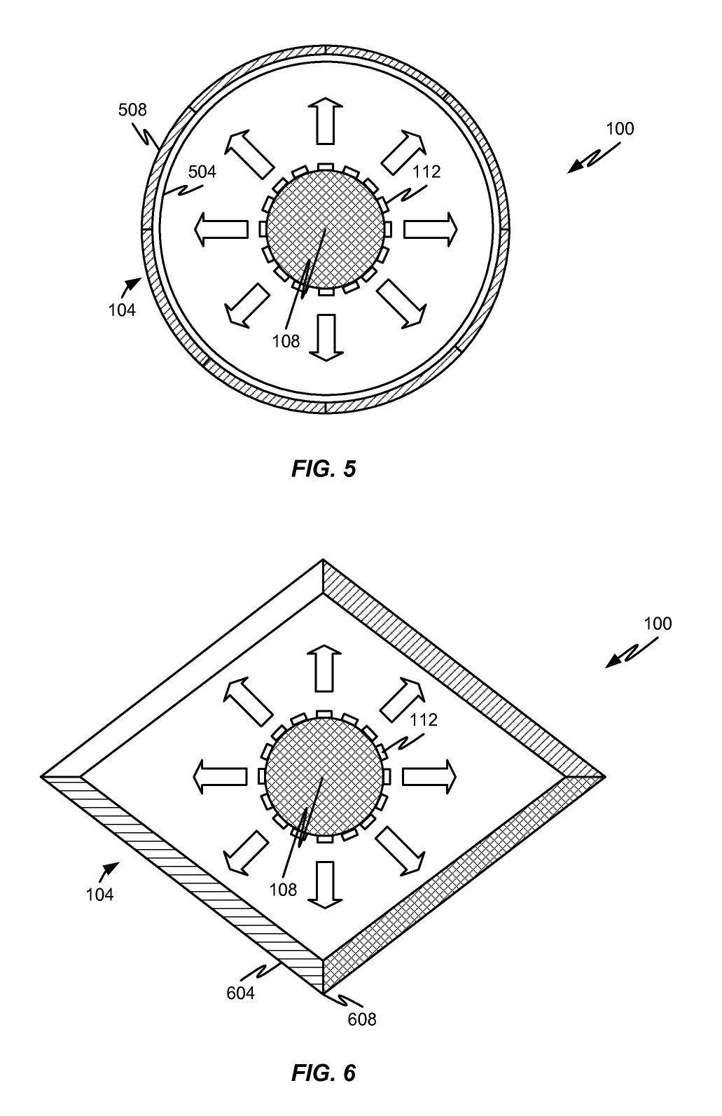

FIG. 6 shows another possible shaft 104 variant in accordance with embodiments of the present disclosure. In particular, the shaft 104 does not necessarily have to be cylindrical in shape. Rather, the shaft 104 may be elliptical in cross section or it may comprise one or more linear edges 604. The linear edges 604 of the shaft 104 may join at an angular junction 608. In some embodiments, each angular junction 608 may also be used as the section boundary 124, although such a configuration is not necessary. Although the non-cylindrical shaft 104 depicted in FIG. 6 has four linear edges 604 and four angular junctions 608, it should be appreciated that the shaft 104 may have any shape. Specifically, the shaft 104 may be comprise any type of cross-sectional shape or combination of shapes along its length (e.g., circular, elliptical, square, hexagonal, pentagonal, triangular, irregular shape, etc.).

It should also be appreciated that any combination of shaft 104 configuration shown in FIGS. 1-6 can be used in accordance with embodiments of the present disclosure. For instance, the configuration shown in FIG. 5 could be employed in combination with the configuration shown in FIG. 6—resulting in a non-cylindrical shaft 104 having a phosphor layer 508 applied to the non-cylindrical shaft substrate 504. As another example, the configuration of FIG. 4 could be employed in combination with the configuration of FIG. 2—resulting in a shaft 104 with the same type of phosphor material throughout that is rotated relative to the core 108. Any other combination of shaft 104 configurations can be employed.

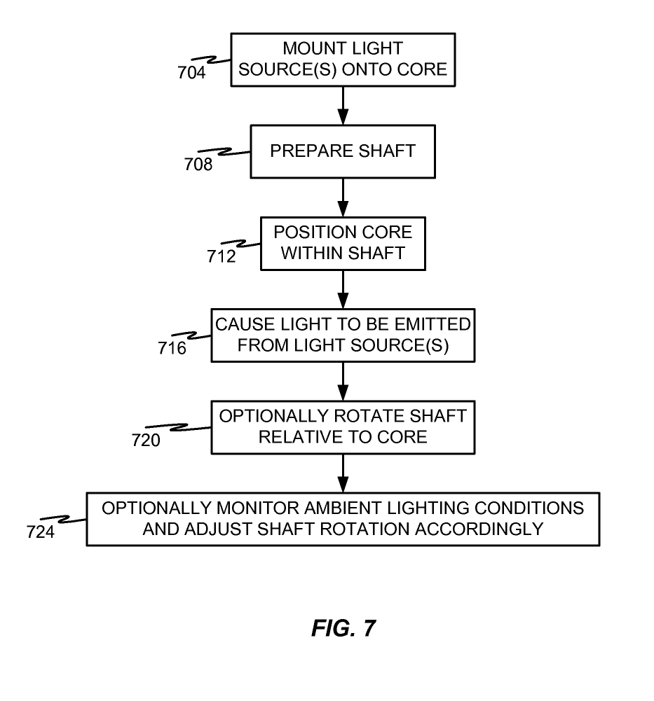

With reference now to FIG. 7, a method of manufacturing and operating an illumination system including the illumination device 100 will be described in accordance with at least some embodiments of the present disclosure. The method is initiated by mounting one or more light source(s) 112 onto a core 108 (step 704). The light source(s) 112 may be thru-hole mounted and/or surface mounted onto the core 108.

Before, during, or after step 704, the selected shaft 708 may be prepared (step 708). In some embodiments, a molding process may be used to manufacture the shaft. In some embodiments, a printing or layer-deposition process may be performed to create a phosphor layer 508 on a shaft substrate 504.

The shaft 104 may then be positioned about the core 108 (step 712). In some embodiments, the core 108 is positioned within the shaft 104. This may be done either during manufacture or by the end-consumer. As noted above, the shaft 104 may be designed for easy replacement by other shafts 104 (e.g., an end-consumer could slide the shaft 104 over the core 108).

Once the shaft 104 has been positioned relative to the core 108 as desired, the illumination device 100 may be placed into the desired position (e.g., it could be placed into a lighting receptacle to replace an old illumination device, such as one according to the present disclosure or an older type of illumination device). The light source(s) 112 may then be activated (e.g., by flipping a switch, pressing a button, or the like) either directly at the illumination device 100, via remote control, or via a wall switch (step 716). Activation of the light source(s) 112 may cause the light source(s) 112 to begin emitting light 116 toward the shaft 104. Depending upon type of shaft 104 used to surround the light source(s) 112, the emitted light 116 may activate some phosphor material in the shaft 104.

In some embodiments, the shaft 104 can be optionally rotated relative to the core 108 (step 720). This step can be done in response to activating the light source(s) 112 or in the absence of illuminating the light source(s) 112. Where rotation of the shaft 104 is performed the lighting conditions about the illumination device 100 may also be optionally monitored and the rotation of the shaft (speed and/or direction) can be controlled based on the detected lighting conditions (step 724).

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. An illumination device, comprising:
a core having at least one light source mounted thereto, the at least one light source being configured to emit light away from the core; and
a rotatable shaft at least partially surrounding the core and including phosphor material such that the light emitted by the at least one light source activates the phosphor material of the rotatable shaft prior to leaving the illumination device.

2. The device of claim 1, wherein the rotatable shaft comprises a first section and a second section, the first section comprising a first type of phosphor material, and the second section comprising a second type of phosphor material that is different from the first type of phosphor material.

3. The device of claim 2, wherein the rotatable shaft comprises a section boundary that separates the first type of phosphor material from the second type of phosphor material.

4. The device of claim 2, wherein the first type of phosphor material produces photoluminescence of a first wavelength and wherein the second type of phosphor material produces photoluminescence of a second wavelength.

5. The device of claim 1, wherein the at least one light source corresponds to a Light Emitting Diode (LED) configured to emit light that is at least one of blue and ultraviolet and wherein the phosphor material emits light at longer wavelengths than is produced by the at least one light source.

6. The device of claim 1, wherein the phosphor material comprises at least one of a copper-activated zinc sulfide and a silver-activated zinc sulfide.

7. The device of claim 1, wherein the core comprises a flexible Printed Circuit Board (PCB) mounted on a heat sink.

8. The device of claim 1, wherein the core is cylindrical.

9. The device of claim 1, wherein the at least one light source comprises an Organic Light Emitting Diode (OLED) sheet or film.

10. The device of claim 1, wherein the shaft comprises a shaft substrate and wherein the phosphor material comprises a film on an outer surface of the shaft substrate.

11. An illumination system, comprising:
a core configured to support one or more Light Emitting Diode (LED) components, the one or more LED components configured to emit light of a predetermined wavelength away from the core; and
a shaft that at least partially encloses the core and the one or more LED components and being configured to be rotated relative to the core, the shaft further comprising phosphor material.

12. The system of claim 11, wherein the predetermined wavelength is greater than or equal to 445 nm.

13. The system of claim 11, further comprising:
a shaft motor operatively coupled to the shaft and configured to rotate the shaft.

14. The system of claim 13, wherein the shaft motor is configured to alter at least one of a speed and direction of rotation of the shaft.

15. The system of claim 14, further comprising:
at least one light sensor, the at least one light sensor being configured to detect light in proximity to the shaft and provide a signal indicative of the detected light to the shaft motor, wherein the shaft motor is further configured to adjust the at least one of speed and direction of rotation of the shaft in response to the signal received from the at least one light sensor.

16. The system of claim 11, wherein the phosphor material comprises at least one of a copper-activated zinc sulfide and a silver-activated zinc sulfide.

17. A method of operating an illumination device, comprising:
mounting one or more light sources onto a core;
positioning the core and the one or more light sources within a shaft having phosphor material, the shaft being physically separated from the core and the one or more light sources by a predetermined distance;
causing the one or more light sources to emit light toward the shaft such that the emitted light activates the phosphor material of the rotatable shaft prior to exiting an outer shaft surface.

18. The method of claim 17, wherein the shaft comprises a first section and a second section, the first section comprising a first type of phosphor material, and the second section comprising a second type of phosphor material that is different from the first type of phosphor material.

19. The method of claim 17, wherein the core comprises a flexible Printed Circuit Board (PCB) mounted on a heat sink.

20. The method of claim 17, further comprising:
rotating the shaft relative to the core, wherein the shaft is rotated in response light conditions detected about the shaft.
